(19) United States
(12) Patent Application Publication
(10) Pub. No.: US 2019/0039515 A1
(43) Pub. Date: Feb. 7, 2019

(54) SYSTEM AND METHOD FOR WARNING AGAINST VEHICULAR COLLISIONS WHEN DRIVING

(71) Applicant: NANNING FUGUI PRECISION INDUSTRIAL CO., LTD., Nanning (CN)

(72) Inventor: WEI-FENG SUN, HsinChu (TW)

(21) Appl. No.: 15/666,488

(22) Filed: Aug. 1, 2017

(51) Int. Cl. B60Q 9/00; G06K 9/00; G06K 9/62; G06T 7/11

(52) U.S. Cl. CPC B60Q 9/008; G06T 7/11; G06K 9/6202; G06K 9/00805

(57) ABSTRACT

A system and method for warning within a vehicle as to an obstacle in front is implemented by an electronic device which is mounted on the vehicle. The electronic device is preconfigured to apply a virtual window frame comprising a determining region of the roadway in front. Real-time image of a visible area is acquired by the electronic device and a target-sub image in the determining region is analyzed to determine whether the vehicle a safe distance away from the obstacle in front.

### FIELD

The subject matter herein generally relates to road traffic safety, in particular to a vehicle warning system.

### BACKGROUND

In order to ensure safety of life and property of vehicle owners, vehicles are equipped with an anti-collision braking system. But the current system has shortcomings that the current system cannot distinguish environmental factors and that the current system requires multiple cameras, thereby resulting in cost.

### BRIEF DESCRIPTION OF THE DRAWINGS

Implementations of the present technology will now be described, by way of example only, with reference to the attached figures, wherein:

FIG. 1 is a block diagram of one embodiment of an electronic device;

FIG. 2 is a block diagram of one embodiment of functional modules of a vehicle warning system of the electronic device of FIG. 1;

FIG. 3 is a block diagram of one embodiment of a window frame and a determining region of the vehicle warning system of FIG. 2;

FIG. 4 is a flowchart of one embodiment of a warning system method;

FIG. 5 is a flowchart of one embodiment of a method for analyzing a target sub-image; and

FIG. 6 is a flowchart of one embodiment of a method for processing pixel values of the sub-target image.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

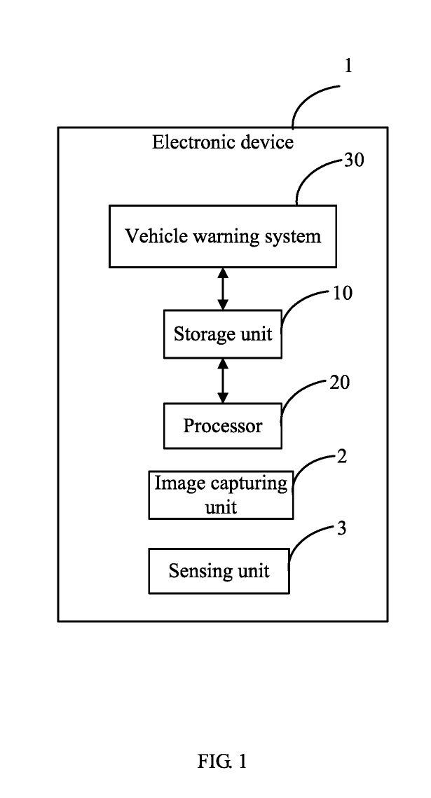

FIG. 1 illustrates a block diagram of an embodiment of an electronic device 1. In the embodiment, the electronic device 1 is mounted on a road vehicle, and the electronic device 1 includes an image capturing unit 2 and a sensing unit 3. The image capturing unit 2 can be an electronic unit having a photographing function, such as a camera. The sensing unit 3 can be a sensor for sensing ambient environment information and for triggering a mode switching of the electronic device 1, for example, switching the mode from daytime driving to nighttime driving. The electronic device 1 further includes a storage unit 10, a processor 20, and a vehicle warning system 30.

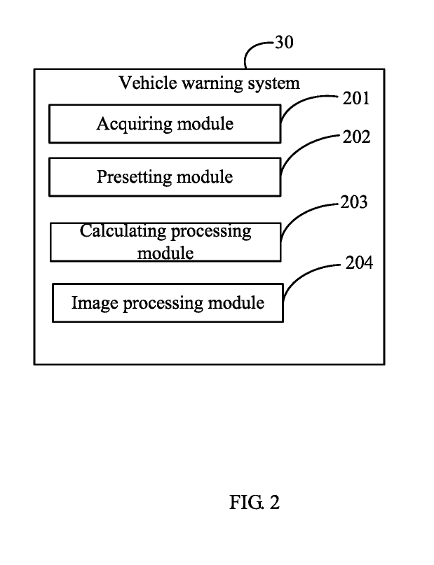

FIG. 2 illustrates a block diagram of an exemplary embodiment of functional modules of the vehicle warning system 30. The vehicle warning system 30 includes an acquiring module 201, a presetting module 202, a calculating processing module 203, and an image processing module 204. The one or more functional modules can include computerized code in the form of one or more programs that are stored in the storage unit 10, and executed by the processor 20 to provide functions of the vehicle warning system 30.

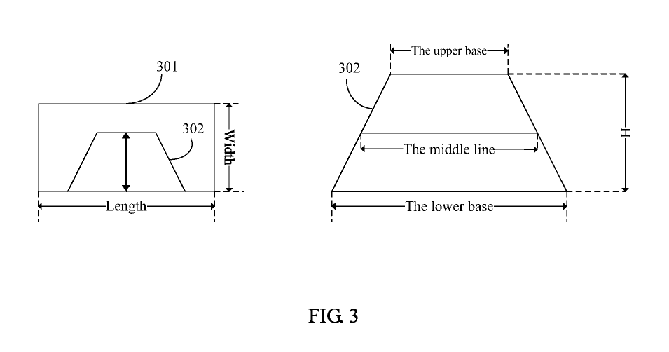

The acquiring module 201 acquires real-time images within an area visible to the electronic device 1. In the embodiment, the electronic device 1 acquires the real-time image through the image capturing unit 2, and the image capturing unit 2 may be a CCD (Charge-coupled Device) camera. The electronic device 1 pre-defines a virtual window frame 301 (as shown in FIG. 3) within the visible area. The window frame 301 can be presented on screen of electronic device 1 according to user's preferences. The window frame 301 is a predefined area for analyzing images acquired by the image capturing unit 2. The size of the window frame 301 is determined by angle range detectable by the image capturing unit 2 and vehicle information of the vehicle on which the electronic device 1 is mounted.

In the embodiment, referring to FIG. 3, the shape of the window frame 301 is a rectangle, and length of the rectangle is proportional to a road width.

The presetting module 202 pre-configures a determining region 302 (as shown in FIG. 3) within the window frame 301 according to a width of the vehicle, a speed of the vehicle, a brake response time of the vehicle, and a safe proximity distance of the vehicle. In the embodiment, the window frame 301 comprises the determining region 302, the window frame 301 presents the real-time image of the visible area to the electronic device 1, the determining region 302 presents the target sub-image. The target sub-image is part of the real-time image.

In the embodiment, the determining region 302 is pre-configured as an echelon. In FIG. 3, UPPER BASE is upper bottom of the echelon, and LOWER BASE is lower bottom of the echelon, where a length of LOWER BASE is proportional to a width of road or the vehicle. The determining region 302 of the present application is not limited to being an echelon, and users can design other shapes according to their preferences.

In general, a vehicle should maintain a distance from the vehicles in front, in order to have enough time to respond to sudden situations by braking. A formula to calculate the braking distance can be as follows: braking distance =stopping distance +reaction distance. The stopping distance is a common safety distance in the traffic system, generally 80 meters. The reaction distance=brake reaction time * vehicle speed. Taking 80 meters safety distance for example, the reaction distance is 20 meters for the vehicle having a speed of 100 KM per hour, so the braking distance is 100 meters. In the embodiment, height of the echelon is proportional to the braking distance. In the embodiment, in order to detect the real-time image information of the window frame 301 more clearly, the determining region 302 is preconfigured as an echelon, wherein the echelon upper base: the middle line: the lower base=1: 2: 3.

The calculating processing module 204 analyses the target sub-image in the determining region 302, and determines whether the vehicle is in a safe state according to an analysis result. When the vehicle is not in the safe state, the calculating processing module 203 outputs a warning information. The form of the warning information can be a flashing light or a voice. In the embodiment, the calculating processing module 203 calculates a sum of pixel values of the target sub-image, and compares the sum with a preset threshold value. When the sum is less than the preset threshold value, the calculating processing module 204 determines that the vehicle is in a safe state. Conversely, when the sum is greater than or equal to the preset threshold value, the calculating processing module 203 determines the vehicle is not in a safe state. In the embodiment, the preset threshold value is set by user according to the user's preference.

In an embodiment, before the step of calculating the sum of pixel values of the target sub-image, the image processing module 204 performs an image processing process on the real-time image, the image processing includes grayscale mapping and binarization processing.

The steps of the calculating processing module 203 to calculate the sum of the pixel values of the target sub-image including grayscale mapping and binarization processing is as follows.

First, the calculating processing module 203 calculates a pixel standard value for the all pixels after grayscale mapping. In one embodiment, the sensing unit 3 senses current weather conditions and reports the weather conditions to the calculating processing module 204. In another embodiment, the weather conditions can be determined through the following formula:
when abs(Mean-Median)>10, the weather conditions are terrible;
when abs(Mean-Median)<=10, the weather conditions are good.
The Mean represents a mean value of the pixel values and the Median represents a median value of the pixel values. In the embodiment, the number 10 is a preset value. The preset value is set according to the actual weather conditions. The function abs( )is used for returning the absolute value of a number.

The calculating processing module 203 calculates the pixel standard value for all pixels according to the weather conditions. In the embodiment, when the weather conditions are good, the pixel standard value is a mean value of the pixel values of all pixels in the target-sub image. When the weather conditions are terrible, the pixel standard value is a median value of the pixel values of all pixels in the target-sub image.

Second, the image processing module 204 performs different binarization processes for each pixel in the determining region according to a current operation mode of the vehicle. In the embodiment, the image processing module 2054 determines the current operation mode of the vehicle according to the sensing unit 3.

When the current operation mode of the vehicle is daytime driving, the pixel value of each pixel in the determining region 302 is less than the pixel standard value because objects are shaded under illumination. Usually, a object has shadows under the sunshine in daytime, so the pixel value of each pixel for the object in front of the vehicle is less than the pixel standard value. The image processing module 204 determines whether the pixel value is less than the pixel standard value for each pixel in the determining region 302. If the pixel value is less than the pixel standard value, the pixel value is changed to 1, otherwise, the pixel value is changed to 0.

When the current operation mode of the vehicle is nighttime driving, the pixel value of each pixel in the determining region 302 is greater than the pixel standard value because the headlights of the user's vehicle irradiate the object in front. The image processing module 205 determines whether the pixel value is greater than the pixel standard value for each pixel in the determining region 302. If the pixel value is greater than the pixel standard value, the pixel value is changed to 1; otherwise, the pixel value is changed to 0.

Finally, the calculating processing module 204 calculates the sum of pixel values of the target sub-image, and compares the sum with a preset threshold value. When the sum is less than the preset threshold value, the calculating processing module 204 determines that the vehicle is in a safe state. Conversely, when the sum is greater than or equal to the preset threshold value, the calculating processing module 204 determines the vehicle is not in a safe state. The calculating processing module 204 outputs warning information. The form of the warning can be a flashing light or a voice

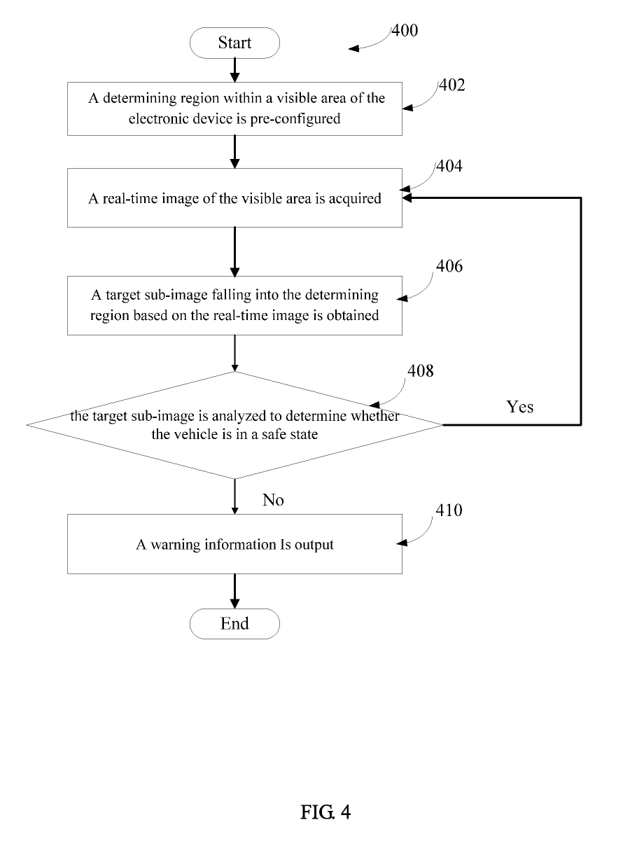

Referring to FIG. 4, a flowchart is presented in accordance with an embodiment of a method 400 for vehicle warning, and the function modules 201-205, as FIG. 2 illustrates, are executed by the processor 10. The method 400 is provided by way of example.

At block 402, a determining region 302 within a visible area of the electronic device is pre-configured. The determining region 302 (as shown in FIG. 3) is pre-configured within the window frame 301 according to a width of the vehicle, a speed of the vehicle, a brake response time of the vehicle, and a safe proximity distance of the vehicle.

At block 404, a real-time image of the visible area of the electronic device 1 is acquired. In the embodiment, the electronic device 1 acquires the real-time image of the visible area through the image capturing unit 2, and the image capturing unit 2 can be a CCD (Charge-coupled Device) camera. The electronic device 1 pre-defined a window frame 301 within the visible area, wherein the window frame 301 is used to analyze the real-time image acquired by the image capturing unit 2. The size of the window frame 301 is determined by angle range the image capturing unit 2 can detect and vehicle information of the vehicle on which the electronic device 1 is mounted. A determining region 302 is pre-configured within the window frame 301 according to a width of the vehicle, a speed of the vehicle, a brake response time of the vehicle and a safety distance of the vehicle. The determining region 302 contains a target sub-image of the real-time image.

At block 406, a target sub-image falling into the determining region based on the real-time image

At block 408, the target-sub image in the determining region 302 is analyzed to determine whether the vehicle is in a safe state is determined. In the embodiment, whether the vehicle is in a safe state is determined according to an analysis result. When the vehicle is not in the safe state, block 410 is executed. When the vehicle is in the safe state, block 404 is executed.

At block 412, warning information is output. The form of the warning information can be a flashing light or a voice.

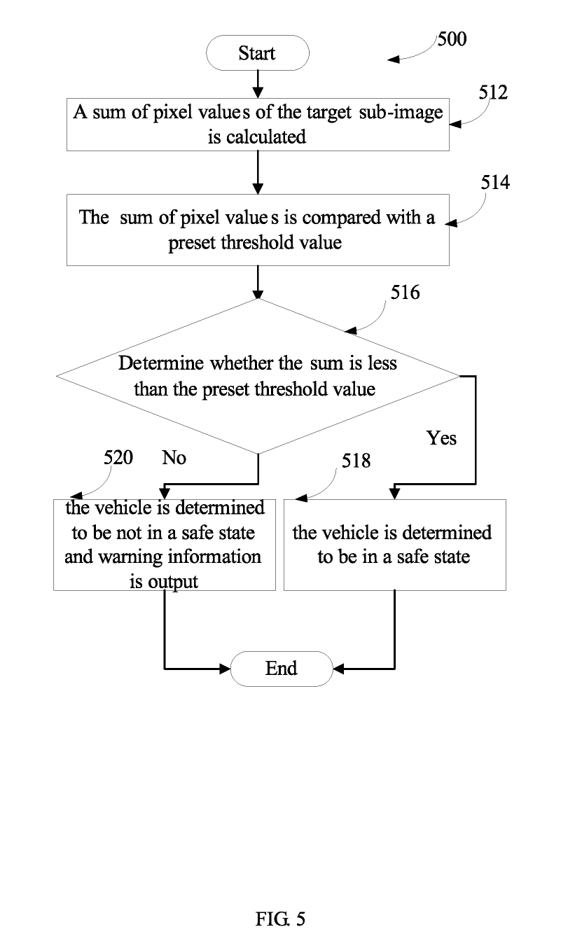

Referring to FIG. 5, a flowchart is presented in accordance with an embodiment of a method 500 for analyzing the target sub-image, and the function modules 201-205 as FIG. 2 illustrates are executed by the processor 10. Each block shown in FIG. 5 represents one or more processes, methods, or subroutines, carried out in the exemplary method 500. Additionally, the illustrated order of blocks is by example only and the order of the blocks can be changed. The method 500 can begin at block 512.

At block 512, a sum of pixel values of the target sub-image is calculated.

At block 514, the sum is compared with a preset threshold value.

At block 516, whether the sum is less than the preset threshold value is determined. When the sum is less than the preset threshold value, block 518 is executed, when the sum of pixel values is greater than or equal to the preset threshold value, block 520 is executed.

At block 518, the vehicle is determined to be in a safe state.

At block 520, the vehicle is determined to be not in a safe state and warning information is output.

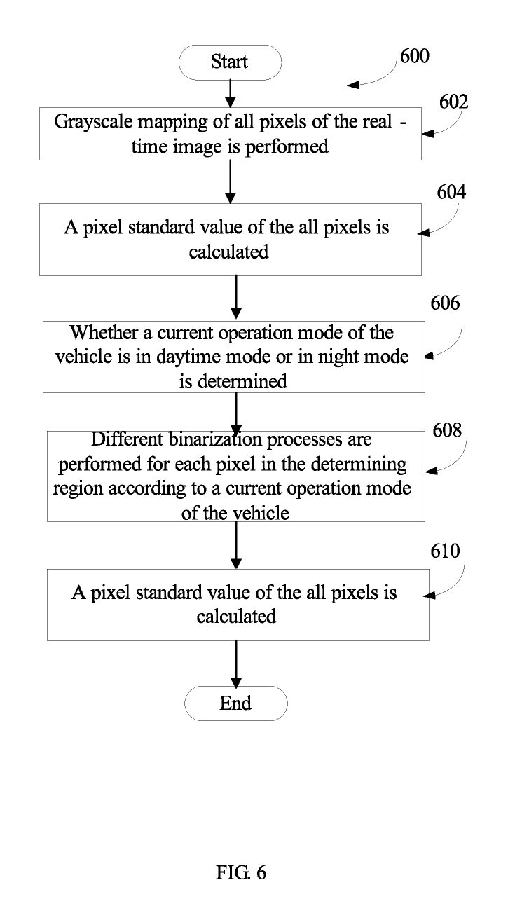

Referring to FIG. 6, a flowchart is presented in accordance with an embodiment of a method 600 for processing pixel values of the target sub-image, and the function modules 201-205, as FIG. 3 illustrates, are executed by the processor 10. The method 600 is provided by way of example.

At block 602, grayscale mapping of all pixels of the real-time image is performed.

At block 604, a pixel standard value of the all pixels is calculated. In one embodiment, the sensing unit 3 senses current weather conditions. In another embodiment, the weather conditions can be determined through the following formula:
when abs(Mean-Median)>10, the weather conditions are terrible;
when abs(Mean-Median)<=10, the weather conditions are great.
   The Mean represents a mean value of the pixel values and the Median represents a median value of the pixel values. In the embodiment, the number 10 is a preset value. The preset value is set according to the actual weather conditions. The function abs( )is used for returning the absolute value of a number. The pixel standard value of all pixels is calculated according to the weather conditions. In the embodiment, when the weather conditions are good, the pixel standard value is a mean value of the pixel values of all pixels in the real-time image. When the weather conditions are terrible, the pixel standard value is a median value of the pixel values of all pixels in the real-time image.

At block 606, whether a current operation mode of the vehicle is daytime driving or in nighttime driving is determined. In the embodiment, the current operation mode of the vehicle is determined according to the sensing unit 3.

At block 608, different binarization processes are performed for each pixel in the determining region 302 according to a current operation mode of the vehicle.

In the embodiment, when the current operation mode of the vehicle is daytime driving, the pixel value of each pixel in the determining region 302 is less than the pixel standard value because the object is shaded under illumination. Usually, an object has shadows under the sunshine in daytime, so the pixel value of each pixel for the object in front of the vehicle is less than the pixel standard value. Whether the pixel value is less than the pixel standard value for each pixel in the determining region 302 is determined. If the pixel value is less than the pixel standard value, the pixel value is changed to 1; otherwise, the pixel value is changed to 0.

When the current operation mode of the vehicle is nighttime driving, the pixel value of the each pixel in the determining region 302 is greater than the pixel standard value because the headlights of the user's vehicle irradiate the object in front. Whether the pixel value is greater than the pixel standard value for each pixel in the determining region 302 is determined. If the pixel value is greater than the pixel standard value, the pixel value is changed to 1; otherwise, the pixel value is changed to 0.

At block 610, a sum of pixel values of the target sub-image is calculated.

The embodiments shown and described above are only examples. Many details are often found in the art such as the other features of a device and method for vehicle warning. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for vehicle warning, executed in an electronic device, the electronic device is mounted on a vehicle, the method comprising:
pre-configuring a determining region within a visible area of the electronic device;
acquiring a real-time image of the visible area;
obtaining a target sub-image falling into the determining region based on the real-time image;
analyzing the target sub-image to determine whether the vehicle is in a safe state.

2. The method as claimed in claim 1, wherein the method further comprises:
outputting a warning information when the vehicle is not in the safe state.

3. The method as claimed in claim 1, wherein the method further comprises:
pre-configuring the determining region according to a width of the vehicle, a speed of the vehicle, a brake response time of the vehicle and a safety distance of the vehicle.

4. The method as claimed in claim 3, the step of analyzing the target sub-image to determine whether the vehicle is in a safe state comprises:
calculating a sum of pixel values of the target sub-image;
comparing the sum with a preset threshold value; and
when the sum is less than the preset threshold value, the vehicle is in a safe state.

5. The method as claimed in claim 4, the step of analyzing the target sub-image to determine whether the vehicle is in a safe state further comprises:
when the sum of pixel values is greater than or equal to the preset threshold value, the vehicle is not in a safe state.

6. The method as claimed in claim 4, before the step of calculating a sum of pixel values of the target image information, the method further comprises:
performing an image processing process on the real-time image, the image processing process includes grayscale mapping and binarization processing.

7. The method as claimed in claim 4, the step of calculating a sum of pixel values of the target sub-image comprises:
calculating a pixel standard value of all pixels of the real-time image;
determining whether a current operation mode of the vehicle is daytime driving or nighttime driving;
performing different binarization processes for each pixel in the determining region according to the current operation mode of the vehicle;
calculating a sum of pixel values of the target sub-image according to the pixel standard value and the current operation mode of the vehicle after the binarization processes.

8. A system for vehicle warning, executed in an electronic device, the electronic device is mounted on a vehicle, the system comprising:
at least one processor;
a storage unit; and
one or more programs that are stored in the storage unit and executed by the at least one processor, the one or more programs comprising instructions for:
pre-configuring a determining region within a visible area of the electronic device;
acquiring a real-time image of the visible area;
obtaining a target sub-image falling into the determining region based on the real-time image;
analyzing the target sub-image to determine whether the vehicle is in a safe state.

9. The system as claimed in claim 8, the one or more programs further comprise instructions for:
outputting a warning information when the vehicle is not in the safe state.

10. The system as claimed in claim 8, the one or more programs further comprise instructions for:
pre-configuring the determining region in the window frame according to a width of the vehicle, a speed of the vehicle, a brake response time of the vehicle and a safety distance of the vehicle.

11. The system as claimed in claim 10, wherein the one or more programs further comprise instructions for:
calculating a sum of pixel values of the target sub-image;
comparing the sum with a preset threshold value; and
when the sum is less than the preset threshold value, the vehicle is in a safe state.

12. The system as claimed in claim 11, wherein the one or more programs further comprise instructions for:
when the sum of pixel values is greater than or equal to the preset threshold value, the vehicle is not in a safe state.

13. The system as claimed in claim 11, wherein the one or more programs further comprise instructions for:
performing an image processing process on the real-time image, the image processing process includes grayscale mapping and binarization processing.

14. The system as claimed in claim 11, wherein the one or more programs further comprise instructions for:
calculating a pixel standard value of all pixels of the real-time image;
determining whether a current operation mode of the vehicle is daytime driving or nighttime driving;
performing different binarization processes for each pixel in the determining region according to the current operation mode of the vehicle;
calculating a sum of pixel values of the target sub-image according to the pixel standard value and the current operation mode of the vehicle after the binarization processes.
